(19) United States
(12) Patent Application Publication
(10) Pub. No.: US 2022/0274463 A1
(43) Pub. Date: Sep. 1, 2022

(54) METHOD FOR CONTROLLING PRESSURE IN VEHICLE THERMAL MANAGEMENT SYSTEM

(71) Applicants: HYUNDAI MOTOR COMPANY, Seoul (KR); Kia Corporation, Seoul (KR)

(72) Inventors: Gyoung Wan KOO, Incheon (KR); Tae Han KIM, Seoul (KR); Jae Hyun SONG, Seoul (KR)

(73) Assignees: HYUNDAI MOTOR COMPANY, Seoul (KR); Kia Corporation, Seoul (KR)

(21) Appl. No.: 17/407,901

(22) Filed: Aug. 20, 2021

(30) Foreign Application Priority Data
Feb. 26, 2021 (KR) 10-2021-0026949

(51) Int. Cl. B60H 1/32; B60H 1/00

(52) U.S. Cl. CPC B60H 1/3205; B60H 1/00278; B60H 2001/3272; B60H 2001/3285; B60H 2001/006

(57) ABSTRACT

A method for controlling pressure in a vehicle thermal management system, includes: determining, by a controller, whether only the battery pack is cooled when cooling of a passenger compartment is desired; stopping, by the controller, the compressor when it is determined that only the battery pack is cooled; determining, by the controller, whether a noise generation condition is satisfied after stopping the compressor.

### CROSS-REFERENCE TO RELATED APPLICATION

This application claims priority to and the benefit of Korean Patent Application No. 10-2021-0026949, filed on Feb. 26, 2021, the entire contents of which are incorporated herein by reference.

### FIELD

The present disclosure relates to a method for controlling pressure in a vehicle thermal management system.

### BACKGROUND

The statements in this section merely provide background information related to the present disclosure and may not constitute prior art.

With a growing interest in energy efficiency and environmental issues, there is a demand for research and development of eco-friendly vehicles that can replace internal combustion engine vehicles. Such eco-friendly vehicles are divided into electric vehicles, which are driven by using fuel cells or electricity as a power source, and hybrid vehicles, which are driven by using an engine and a battery system.

Existing electric vehicles and hybrid vehicles have employed an air-cooled battery cooling system using indoor cold air. In recent years, research is underway on a water-cooled battery cooling system that cools the battery by water cooling in order to extend all electric range (AER) to 300 km (200 miles) or more. Specifically, energy density may be increased by adopting a structure that cools the battery in a water-cooled manner using a heating, ventilation, and air conditioning (HVAC) system, a radiator, and the like. In addition, the water-cooled battery cooling system may make the battery system compact by reducing gaps between battery cells, and improve battery performance and durability by maintaining a uniform temperature between the battery cells.

In order to implement the above-described water-cooled battery cooling system, research is being conducted on a vehicle thermal management system integrated with a power train cooling subsystem for cooling an electric motor and electric/electronic components, a battery cooling subsystem for cooling a battery, and an HVAC subsystem for heating or cooling the air in the passenger compartment of the vehicle.

The power train cooling subsystem includes a power train coolant loop through which a coolant circulates, and the power train coolant loop may be fluidly connected to the electric motor, the electric/electronic components (an inverter, etc.), a radiator, a circulation pump, and a reservoir tank. The coolant cooled by the radiator may cool the electric motor and the electric/electronic components.

The battery cooling subsystem includes a battery coolant loop through which the coolant circulates, and the battery coolant loop may be fluidly connected to the battery, a heater, a battery chiller, and a circulation pump. The coolant cooled by the battery chiller may cool the battery.

The HVAC subsystem includes a refrigerant loop through which a refrigerant circulates, and the refrigerant loop of the HVAC subsystem may be fluidly connected to an evaporator, a compressor, an interior condenser, an exterior condenser, a first expansion valve, a second expansion valve, and the battery chiller. The evaporator, the interior condenser, and an air mixing door may be arranged in an HVAC duct. The HVAC duct may have an inlet through which the air is allowed to draw in, and a plurality of outlets through which the air is directed into the passenger compartment. The evaporator may cool the air, the interior condenser may heat the air, which is directed into the passenger compartment, and the air mixing door (also referred to as a “temperature door”) may be disposed between the evaporator and the interior condenser. The evaporator may be located upstream of the air mixing door, and the interior condenser may be located downstream of the air mixing door. The air mixing door may adjust the flow rate of air passing through the interior condenser, thereby controlling the temperature of the air entering the passenger compartment.

In addition, the HVAC subsystem includes a branch conduit branching off from the refrigerant loop, and the battery chiller may be fluidly connected to the branch conduit. The first expansion valve may be located on the inlet side (upstream side) of the evaporator, and the second expansion valve may be located on the inlet side (upstream side) of the battery chiller. The battery chiller may be configured to transfer heat between the coolant circulating in the battery coolant loop and a portion of the refrigerant passing through the branch conduit. Accordingly, the coolant circulating in the battery coolant loop may be cooled by the battery chiller, and the coolant cooled by the battery chiller may cool the battery.

The above-described thermal management system of the electric vehicle may perform cooling of the passenger compartment and/or cooling of the battery by one compressor, and the cooling of the passenger compartment and the cooling of the battery are not always performed at the same time.

When only the battery is to be cooled without cooling the passenger compartment, the first expansion valve is closed, and the second expansion valve is opened. The refrigerant does not flow into the first expansion valve and the evaporator, but is only directed into the battery chiller, and accordingly the coolant cooled by the battery chiller cools the battery. When the cooling of the passenger compartment is desired during the cooling of the battery, the first expansion valve is suddenly opened, and accordingly a differential pressure between an inlet side (upstream side) pressure and an outlet side (downstream side) pressure of the first expansion valve may increase excessively. Due to such an excessive differential pressure in the first expansion valve, the refrigerant may rapidly flow into the first expansion valve, which causes severe noise in the first expansion valve of the HVAC subsystem.

In order to inhibit such noise, it is desired to stop the compressor during the cooling of the battery. In particular, the cause of noise generation may be removed by stopping the compressor until the inlet side (upstream side) pressure and the outlet side (downstream side) pressure of the first expansion valve are in equilibrium. However, since the time for equilibrium between the inlet side (upstream side) pressure and the outlet side (downstream side) pressure of the first expansion valve is relatively long (approximately seven minutes), the stop time of the compressor becomes excessively long, which delays cooling and dehumidification of the passenger compartment, resulting in customer complaints.

The above information described in this background section is provided to assist in understanding the background of the inventive concept, and may include any technical concept which is not considered as the prior art that is already known to those skilled in the art.

### SUMMARY

An aspect of the present disclosure provides a method for controlling pressure in a vehicle thermal management system capable of controlling pressure in a refrigerant loop of a heating, ventilation, and air conditioning (HVAC) subsystem when the cooling of a passenger compartment is performed during the cooling of a battery, thereby inhibiting the generation of noise.

According to one aspect of the present disclosure, a method for controlling pressure in a vehicle thermal management system including an HVAC subsystem having a first expansion valve, a battery cooling subsystem, a battery chiller, and a second expansion valve may include: determining, by a controller, whether only a battery pack of the battery cooling subsystem is cooled when cooling of a passenger compartment is desired; stopping, by the controller, an operation of a compressor of the HVAC subsystem when it is determined that only the battery pack is cooled; determining, by the controller, whether a noise generation condition is satisfied after stopping the operation of the compressor; and opening, by the controller, the second expansion valve when it is determined that the noise generation condition is satisfied. The noise generation condition may be a condition in which noise is generated in the first expansion valve when a shut-off valve is opened. The HVAC subsystem may include an evaporator, the compressor, a condenser, the first expansion valve located upstream of the evaporator, and a refrigerant loop fluidly connected to the shut-off valve that is configured to open and close to block or unblock the flow of a refrigerant into the first expansion valve, the battery cooling subsystem may include a battery coolant loop fluidly connected to the battery pack, the battery chiller may be configured to transfer heat between a branch conduit, which branches off from the refrigerant loop, and the battery coolant loop, and the second expansion valve may be located upstream of the battery chiller in the branch conduit.

The controller may determine that only the battery pack is cooled when the compressor operates, the shut-off valve is closed, and the second expansion valve is opened.

The controller may determine that the noise generation condition is satisfied when a pressure of a high-pressure refrigerant in the refrigerant loop is higher than a reference pressure.

The controller may determine that the noise generation condition is satisfied when a differential pressure between an upstream side pressure and a downstream side pressure of the first expansion valve is higher than a reference differential pressure.

The controller may determine that the noise generation condition is satisfied when a temperature of the refrigerant circulating through the refrigerant loop is higher than a reference temperature.

The controller may repeatedly determine whether the noise generation condition is satisfied after the second expansion valve is opened and a predetermined time has elapsed.

The method may further include closing, by the controller, the second expansion valve, opening the shut-off valve, and operating the compressor when it is determined that the noise generation condition is not satisfied.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 illustrates a vehicle thermal management system according to an exemplary form of the present disclosure;

FIG. 2 illustrates a flowchart of a method for controlling pressure in a vehicle thermal management system according to an exemplary form of the present disclosure; and

FIG. 3 illustrates a graph of the pressure of a refrigerant, RPM of a compressor, and the opening degree of a second expansion valve when a method for controlling pressure in a vehicle thermal management system according to an exemplary form of the present disclosure is performed.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, exemplary forms of the present disclosure will be described in detail with reference to the accompanying drawings. In the drawings, the same reference numerals will be used throughout to designate the same or equivalent elements. In addition, a detailed description of well-known techniques associated with the present disclosure will be ruled out in order not to unnecessarily obscure the gist of the present disclosure.

Terms such as first, second, A, B, (a), and (b) may be used to describe the elements in exemplary forms of the present disclosure. These terms are only used to distinguish one element from another element, and the intrinsic features, sequence or order, and the like of the corresponding elements are not limited by the terms. Unless otherwise defined, all terms used herein, including technical or scientific terms, have the same meanings as those generally understood by those with ordinary knowledge in the field of art to which the present disclosure belongs. Such terms as those defined in a generally used dictionary are to be interpreted as having meanings equal to the contextual meanings in the relevant field of art, and are not to be interpreted as having ideal or excessively formal meanings unless clearly defined as having such in the present application.

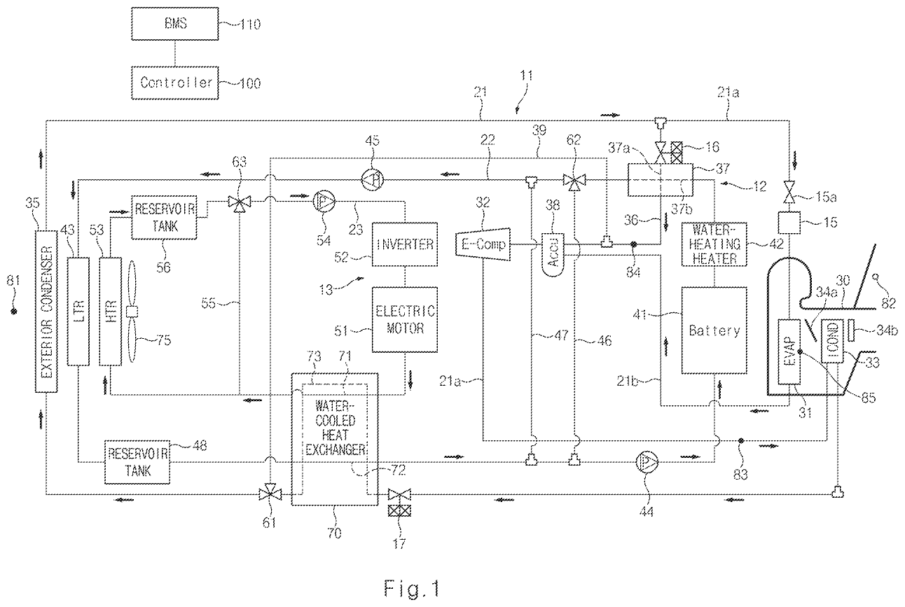

Referring to FIG. 1, a vehicle thermal management system according to an exemplary form of the present disclosure may include a heating, ventilation, and air conditioning (HVAC) subsystem 11 for heating or cooling air in a passenger compartment of the vehicle, a battery cooling subsystem 12 for cooling a battery pack 41, and a power train cooling subsystem 13 for cooling an electric motor 51 and relevant electric/electronic components 52.

The vehicle thermal management system according to an exemplary form of the present disclosure may further include a water-cooled heat exchanger 70 configured to transfer heat among a refrigerant loop 21 of the HVAC subsystem 11, a battery coolant loop 22 of the battery cooling subsystem 12, and a power train coolant loop 23 of the power train cooling subsystem 13.

The HVAC subsystem 11 may include the refrigerant loop 21 through which a refrigerant circulates. The refrigerant loop 21 may be fluidly connected to an evaporator 31, a compressor 32, an interior condenser 33, an exterior condenser 35, and a first expansion valve 15. In FIG. 1, the refrigerant may sequentially pass through the evaporator 31, the compressor 32, the interior condenser 33, the exterior condenser 35, and the first expansion valve 15 through the refrigerant loop 21.

The evaporator 31 may be configured to cool the air using the refrigerant cooled by the exterior condenser 35.

The compressor 32 may be configured to compress the refrigerant which is received from the evaporator 31. For example, the compressor 32 may be an electric compressor which is driven by electric energy.

The interior condenser 33 may be configured to condense the refrigerant, which is received from the compressor 32, and accordingly the air passing over or around the interior condenser 33 may be heated by the interior condenser 33.

The exterior condenser 35 may be disposed adjacent to a front grille of the vehicle. The exterior condenser 35 may be configured to condense the refrigerant, which is received from the interior condenser 33. In particular, the exterior condenser 35 may cool the refrigerant using the outdoor air forcibly blown by a cooling fan 75 so that the refrigerant may be condensed.

The first expansion valve 15 may be disposed between the exterior condenser 35 and the evaporator 31 in the refrigerant loop 21. As the first expansion valve 15 is located on the upstream side of the evaporator 31, the first expansion valve 15 may adjust the flow or flow rate of the refrigerant flowing into the evaporator 31. The first expansion valve 15 may be configured to expand the refrigerant, which is received from the exterior condenser 35. The first expansion valve 15 may be a thermal expansion valve (TXV) which senses the temperature and/or pressure of the refrigerant and adjusts the opening degree of the first expansion valve 15.

According to an exemplary form of the present disclosure, the first expansion valve 15 may be TXV having a shut-off valve 15a selectively blocking the flow of the refrigerant into an internal passage of the first expansion valve 15, and the shut-off valve 15a may be a solenoid valve. A controller 100 may control the shut-off valve 15a to open or close, so that the flow of the refrigerant into the first expansion valve 15 may be blocked or unblocked. As the shut-off valve 15a is opened, the refrigerant may be allowed to flow into the first expansion valve 15, and as the shut-off valve 15a is closed, the refrigerant may be blocked from flowing into the first expansion valve 15. For example, the shut-off valve 15a may be mounted in the inside of a valve body of the first expansion valve 15, thereby opening or closing the internal passage of the first expansion valve 15. As another example, the shut-off valve 15a may be located on the upstream side of the first expansion valve 15, thereby selectively opening or closing an inlet of the first expansion valve 15.

When the shut-off valve 15a is closed, the first expansion valve 15 may be blocked, and accordingly the refrigerant may only be directed into a battery chiller 37 without flowing into the first expansion valve 15 and the evaporator 31. That is, when the shut-off valve 15a of the first expansion valve 15 is closed, the cooling of the HVAC subsystem 11 may not be performed, but only the battery chiller 37 may be cooled. When the shut-off valve 15a is opened, the refrigerant may be directed into the first expansion valve 15 and the evaporator 31. That is, when the shut-off valve 15a of the first expansion valve 15 is opened, the cooling of the HVAC subsystem 11 may be performed.

The HVAC subsystem 11 may include an HVAC duct 30 allowing the air to be directed into the passenger compartment of the vehicle, and the evaporator 31 and the interior condenser 33 may be located within the HVAC duct 30. An air mixing door 34a may be disposed between the evaporator 31 and the interior condenser 33, and a positive temperature coefficient (PTC) heater 34b may be located on the downstream side of the interior condenser 33.

The HVAC subsystem 11 may further include an accumulator 38 disposed between the evaporator 31 and the compressor 32 in the refrigerant loop 21, and the accumulator 38 may be located on the downstream side of the evaporator 31. The accumulator 38 may separate a liquid refrigerant from the refrigerant, which is received from the evaporator 31, thereby inhibiting the liquid refrigerant from flowing into the compressor 32.

The HVAC subsystem 11 may further include a branch conduit 36 branching off from the refrigerant loop 21. The branch conduit 36 may branch off from an upstream point of the first expansion valve 15 in the refrigerant loop 21 and be connected to the compressor 32. The battery chiller 37 may be fluidly connected to the branch conduit 36, and the battery chiller 37 may be configured to transfer heat between the branch conduit 36 and the battery coolant loop 22 to be described below. The battery chiller 37 may include a first passage 37a fluidly connected to the branch conduit 36 and a second passage 37b fluidly connected to the battery coolant loop 22. The first passage 37a and the second passage 37b may be adjacent to or contact each other within the battery chiller 37, and the first passage 37a may be fluidly separated from the second passage 37b. The battery chiller 37 may transfer heat between the coolant passing through the second passage 37b and the refrigerant passing through the first passage 37a. The branch conduit 36 may be fluidly connected to the accumulator 38, and the refrigerant passing through the branch conduit 36 may be received in the accumulator 38.

A second expansion valve 16 may be located on the upstream side of the battery chiller 37 in the branch conduit 36. The second expansion valve 16 may adjust the flow or flow rate of the refrigerant flowing into the battery chiller 37, and the second expansion valve 16 may be configured to expand the refrigerant, which is received from the exterior condenser 35.

For example, the second expansion valve 16 may be an electronic expansion valve (EXV) having a drive motor 16a. The drive motor 16a may have a shaft, which is movable to open or close an internal passage defined in a valve body of the second expansion valve 16, and the position of the shaft may be varied depending on the rotation direction, rotation degree, and the like of the drive motor 16a, and accordingly the opening degree of the internal passage of the second expansion valve 16 may be varied. The controller 100 may control the operation of the drive motor 16a.

According to an exemplary form, the controller 100 may be a full automatic temperature control (FATC) system.

As the opening degree of the second expansion valve 16 is varied, the flow rate of the refrigerant into the battery chiller 37 may be varied. For example, when the opening degree of the second expansion valve 16 is greater than a reference opening degree, the flow rate of the refrigerant into the battery chiller 37 may increase compared to a reference flow rate, and when the opening degree of the second expansion valve 16 is less than the reference opening degree, the flow rate of the refrigerant into the battery chiller 37 may be similar to the reference flow rate or decrease compared to the reference flow rate. Here, the reference opening degree may be an opening degree of the second expansion valve 16 for maintaining a target evaporator temperature, and the reference flow rate may be a flow rate of the refrigerant which is allowed to flow into the battery chiller 37 when the second expansion valve 16 is opened to the reference opening degree. When the second expansion valve 16 is opened to the reference opening degree, the refrigerant may be directed into the battery chiller 37 at the corresponding reference flow rate.

As the opening degree of the first expansion valve 15 and the opening degree of the second expansion valve 16 are adjusted by the controller 100, the refrigerant may be distributed into the evaporator 31 and the battery chiller 37 at a predetermined ratio, and thus the cooling of the HVAC subsystem 11 and the cooling of the battery chiller 37 may be performed simultaneously or selectively.

The HVAC subsystem 11 may further include a refrigerant bypass conduit 39 fluidly connected to the branch conduit 36. The refrigerant bypass conduit 39 may connect the branch conduit 36 to the refrigerant loop 21. Specifically, one end of the refrigerant bypass conduit 39 may be connected to a point between the battery chiller 37 and the accumulator 38 in the branch conduit 36, and the other end of the refrigerant bypass conduit 39 may be connected to a point between the exterior condenser 35 and the water-cooled heat exchanger 70 in the refrigerant loop 21. A first three-way valve 61 may be disposed at a junction between the refrigerant bypass conduit 39 and the refrigerant loop 21.

The controller 100 may control respective operations of the first expansion valve 15, the second expansion valve 16, the compressor 32, and the like of the HVAC subsystem 11, so that the overall operation of the HVAC subsystem 11 may be controlled by the controller 100.

The battery cooling subsystem 12 may include the battery coolant loop 22 through which a coolant circulates. The battery coolant loop 22 may be fluidly connected to the battery pack 41, a heater 42, the battery chiller 37, a second circulation pump 45, a battery radiator 43, a reservoir tank 48, and a first circulation pump 44. In FIG. 1, the coolant may sequentially pass through the battery pack 41, the heater 42, the battery chiller 37, the second circulation pump 45, the battery radiator 43, the reservoir tank 48, the water-cooled heat exchanger 70, and the first circulation pump 44 through the battery coolant loop 22.

The battery pack 41 may have a coolant passage provided inside or outside the battery pack 41, the coolant may pass through the coolant passage, and the battery coolant loop 22 may be fluidly connected to the coolant passage of the battery pack 41.

The heater 42 may be disposed between the battery chiller 37 and the battery pack 41. The heater 42 may heat the coolant circulating through the battery coolant loop 22, thereby warming-up the coolant. For example, the heater 42 may be a water-heating heater that heats the coolant by heat exchange with a high-temperature fluid. As another example, the heater 42 may be an electric heater.

The battery radiator 43 may be disposed adjacent to the front grille of the vehicle, and the battery radiator 43 may be cooled by the outdoor air forcibly blown by the cooling fan 75. The battery radiator 43 may be adjacent to the exterior condenser 35.

The first circulation pump 44 may be disposed between the battery radiator 43 and the battery pack 41 in the battery coolant loop 22, and the first circulation pump 44 may allow the coolant to circulate.

The second circulation pump 45 may be disposed between the battery radiator 43 and the battery chiller 37 in the battery coolant loop 22, and the second circulation pump 45 may allow the coolant to circulate.

The reservoir tank 48 may be disposed between an outlet of the battery radiator 43 and an inlet of the first circulation pump 44.

The battery cooling subsystem 12 may further include a first battery bypass conduit 46 allowing the coolant to bypass the battery radiator 43. The first battery bypass conduit 46 may directly connect an upstream point of the battery radiator 43 and a downstream point of the battery radiator 43 in the battery coolant loop 22.

An inlet of the first battery bypass conduit 46 may be connected to a point between the battery chiller 37 and an inlet of the battery radiator 43 in the battery coolant loop 22. Specifically, the inlet of the first battery bypass conduit 46 may be connected to a point between the battery chiller 37 and an inlet of the second circulation pump 45 in the battery coolant loop 22.

An outlet of the first battery bypass conduit 46 may be connected to a point between the battery chiller 37 and the outlet of the battery radiator 43 in the battery coolant loop 22. Specifically, the outlet of the first battery bypass conduit 46 may be connected to a point between the inlet of the first circulation pump 44 and an outlet of the reservoir tank 48 in the battery coolant loop 22.

As the coolant flows from the downstream side of the battery chiller 37 to the upstream side of the first circulation pump 44 through the first battery bypass conduit 46, the coolant may bypass the second circulation pump 45, the battery radiator 43, the reservoir tank 48, and the water-cooled heat exchanger 70, and accordingly the coolant passing through the first battery bypass conduit 46 may sequentially flow through the battery pack 41, the heater 42, and the battery chiller 37 by the first circulation pump 44.

The battery cooling subsystem 12 may further include a second battery bypass conduit 47 allowing the coolant to bypass the battery pack 41, the heater 42, and the battery chiller 37. The second battery bypass conduit 47 may directly connect a downstream point of the battery chiller 37 and an upstream point of the battery pack 41 in the battery coolant loop 22.

An inlet of the second battery bypass conduit 47 may be connected to a point between the outlet of the first battery bypass conduit 46 and the outlet of the battery radiator 43 in the battery coolant loop 22. Specifically, the inlet of the second battery bypass conduit 47 may be connected to a point between the outlet of the first battery bypass conduit 46 and the outlet of the reservoir tank 48 in the battery coolant loop 22.

An outlet of the second battery bypass conduit 47 may be connected to a point between the inlet of the first battery bypass conduit 46 and the inlet of the battery radiator 43 in the battery coolant loop 22. Specifically, the outlet of the second battery bypass conduit 47 may be connected to a point between the inlet of the first battery bypass conduit 46 and the inlet of the second circulation pump 45 in the battery coolant loop 22.

As the coolant flows from the downstream side of the battery radiator 43 to the upstream side of the second circulation pump 45 through the second battery bypass conduit 47, the coolant may bypass the battery pack 41, the heater 42, and the battery chiller 37, and accordingly the coolant passing through the second battery bypass conduit 47 may sequentially flow through the battery radiator 43, the reservoir tank 48, and the water-cooled heat exchanger 70 by the second circulation pump 45.

The first battery bypass conduit 46 and the second battery bypass conduit 47 may be parallel to each other.

The battery cooling subsystem 12 may further include a second three-way valve 62 disposed at the inlet of the first battery bypass conduit 46. That is, the second three-way valve 62 may be disposed at a junction between the inlet of the first battery bypass conduit 46 and the battery coolant loop 22. The first circulation pump 44 and the second circulation pump 45 may selectively operate depending on a switching operation of the second three-way valve 62. For example, when the second three-way valve 62 opens the inlet of the first battery bypass conduit 46, a portion of the coolant may flow through the first battery bypass conduit 46 to bypass the battery radiator 43, and the remaining coolant may flow through the second battery bypass conduit 47 to bypass the battery pack 41, the heater 42, and the battery chiller 37. When the second three-way valve 62 closes the inlet of the first battery bypass conduit 46, the coolant may not pass through the first battery bypass conduit 46 and the second battery bypass conduit 47. That is, the coolant may selectively pass through the first battery bypass conduit 46 and the second battery bypass conduit 47 by the switching operation of the second three-way valve 62. The coolant passing through the first battery bypass conduit 46 may bypass the second circulation pump 45, the battery radiator 43, the reservoir tank 48, and the water-cooled heat exchanger 70, so that the coolant may sequentially pass through the battery pack 41, the heater 42, and the battery chiller 37 by the first circulation pump 44. The coolant passing through the second battery bypass conduit 47 may bypass the first circulation pump 44, the battery pack 41, the heater 42, and the battery chiller 37, so that the coolant may sequentially pass through the battery radiator 43, the reservoir tank 48, and the water-cooled heat exchanger 70 by the second circulation pump 45.

The battery cooling subsystem 12 may be controlled by a battery management system 110. The battery management system 110 may monitor the state of the battery pack 41, and perform the cooling of the battery pack 41 when the temperature of the battery pack 41 is higher than or equal to a predetermined temperature. The battery management system 110 may transmit an instruction for the cooling operation of the battery pack 41 to the controller 100, and accordingly the controller 100 may control the operation of the compressor 32 and the opening of the second expansion valve 16. When the operation of the HVAC subsystem 11 is not desired during the cooling operation of the battery pack 41, the controller 100 may control the closing of the first expansion valve 15. In addition, the battery management system 110 may control the operation of the first circulation pump 44 and the switching operation of the second three-way valve 62 so that the coolant may bypass the battery radiator 43 and circulate the battery pack 41 and the battery chiller 37.

The power train cooling subsystem 13 may further include the power train coolant loop 23 through which the coolant circulates. The power train coolant loop 23 may be fluidly connected to the electric motor 51, a power train radiator 53, a reservoir tank 56, a third circulation pump 54, and the electric/electronic components 52. In FIG. 1, the coolant may sequentially pass through the electric motor 51, the power train radiator 53, the reservoir tank 56, the third circulation pump 54, and the electric/electronic components 52 through the power train coolant loop 23.

The electric motor 51 may have a coolant passage through which the coolant passes inside or outside the electric motor 51, and the power train coolant loop 23 may be fluidly connected to the coolant passage of the electric motor 51.

The electric/electronic components 52 may be one or more electric/electronic components related to the driving of the electric motor 51, such as an inverter, an on-board charger (OBC), and a low DC-DC converter (LDC). The electric/electronic components 52 may have a coolant passage through which the coolant passes inside or outside the electric/electronic components 52, and the power train coolant loop 23 may be fluidly connected to the coolant passage of the electric/electronic components 52.

The power train radiator 53 may be disposed adjacent to the front grille of the vehicle, and the power train radiator 53 may be cooled by the outdoor air forcibly blown by the cooling fan 75. The exterior condenser 35, the battery radiator 43, and the power train radiator 53 may be disposed adjacent to each other on the front of the vehicle, and the cooling fan may be disposed behind the exterior condenser 35, the battery radiator 43, and the power train radiator 53.

The third circulation pump 54 may be located on the upstream side of the electric motor 51 and the electric/electronic components 52, and the third circulation pump 54 may allow the coolant to circulate in the power train coolant loop 23.

The power train cooling subsystem 13 may further include a power train bypass conduit 55 allowing the coolant to bypass the power train radiator 53. The power train bypass conduit 55 may directly connect an upstream point of the power train radiator 53 and a downstream point of the power train radiator 53 in the power train coolant loop 23 so that the coolant may flow from an outlet of the electric motor 51 into an inlet of the third circulation pump 54 through the power train bypass conduit 55, and accordingly the coolant may bypass the power train radiator 53.

An inlet of the power train bypass conduit 55 may be connected to a point between the electric motor 51 and the power train radiator 53 in the power train coolant loop 23. An outlet of the power train bypass conduit 55 may be connected to a point between the reservoir tank 56 and the electric/electronic components 52 in the power train coolant loop 23. Specifically, the outlet of the power train bypass conduit 55 may be connected to a point between the reservoir tank 56 and the inlet of the third circulation pump 54 in the power train coolant loop 23.

The power train cooling subsystem 13 may further include a third three-way valve 63 disposed at the outlet of the power train bypass conduit 55. The coolant may bypass the power train radiator 53 through the power train bypass conduit 55 by a switching operation of the third three-way valve 63, so that the coolant may sequentially pass through the electric motor 51, the third circulation pump 54, and the electric/electronic components 52.

The reservoir tank 56 may be located on the downstream side of the power train radiator 53. In particular, the reservoir tank 56 may be disposed between the power train radiator 53 and the third three-way valve 63 in the power train coolant loop 23.

In the power train cooling subsystem 13, the switching operation of the third three-way valve 63 and the operation of the third circulation pump 54 may be controlled by the controller 100.

The water-cooled heat exchanger 70 may recover waste heat from the electric motor 51 and the electric/electronic components 52 of the power train cooling subsystem 13 and transfer the waste heat to the HVAC subsystem 11 and/or the battery cooling subsystem 12 during the heating operation of the HVAC subsystem 11. Specifically, the water-cooled heat exchanger 70 may include a first passage 71 fluidly connected to the power train coolant loop 23, a second passage 72 fluidly connected to the battery coolant loop 22, and a third passage 73 fluidly connected to the refrigerant loop 21.

The refrigerant loop 21 of the HVAC subsystem 11 may further include a third expansion valve 17 disposed between the interior condenser 33 and the water-cooled heat exchanger 70. The third expansion valve 17 may be a full open type EXV. The opening degree of the third expansion valve 17 may be varied by the controller 100. As the opening degree of the third expansion valve 17 is varied, the flow rate of the refrigerant into the third passage 73 may be varied. The third expansion valve 17 may operate during the heating operation of the HVAC subsystem 11.

The first three-way valve 61 may be disposed between the exterior condenser 35 and the water-cooled heat exchanger 70 in the refrigerant loop 21.

The refrigerant loop 21 of the HVAC subsystem 11 may be divided into a high-pressure refrigerant conduit 21a extending from an outlet of the compressor 32 to the inlet of the first expansion valve 15, and a low-pressure refrigerant conduit 21b extending from an outlet of the first expansion valve 15 to an inlet of the compressor 32. The refrigerant present in the high-pressure refrigerant conduit 21a may be a high-pressure refrigerant having a relatively high pressure due to compression of the compressor 32. The outlet of the compressor 32, the interior condenser 33, and the exterior condenser 35 may be fluidly connected to the high-pressure refrigerant conduit 21a. The refrigerant present in the low-pressure refrigerant conduit 21b may be a low-pressure refrigerant having a relatively low pressure due to expansion of the first expansion valve 15. The outlet of the first expansion valve 15, the evaporator 31, and the accumulator 38 may be fluidly connected to the low-pressure refrigerant conduit 21b. In addition, the refrigerant present in the branch conduit 36 may have a relatively low pressure due to expansion of the second expansion valve 16. The low-pressure refrigerant conduit 21b may communicate with the branch conduit 36 through the accumulator 38.

The vehicle thermal management system according to an exemplary form of the present disclosure may include an outdoor air temperature sensor 81 measuring an outdoor air temperature of the vehicle, a humidity sensor 82 measuring a humidity in the passenger compartment of the vehicle, a high-pressure side pressure sensor 83 measuring a pressure of the high-pressure refrigerant to check whether there is a failure, a low-pressure side pressure/temperature sensor 84 disposed on the downstream side of the second expansion valve 16 in the branch conduit 36, and an evaporator temperature sensor 85 measuring a temperature of the evaporator 31.

The outdoor air temperature sensor 81 may be disposed adjacent to the front grille of the vehicle to measure the outdoor air temperature of the vehicle, and the measured outdoor air temperature may be used for optimal control of the HVAC subsystem 11.

The humidity sensor 82 may be disposed within the passenger compartment to measure an indoor humidity in the passenger compartment, and the measured humidity may be used for optimal control of the HVAC subsystem 11.

The high-pressure side pressure sensor 83 may be disposed in the high-pressure refrigerant conduit 21a to thereby measure the pressure of the high-pressure refrigerant present in the high-pressure refrigerant conduit 21a. By detecting that the pressure of the high-pressure refrigerant measured by the high-pressure side pressure sensor 83 falls below a lower limit pressure, it may be confirmed that the refrigerant is reduced or absent in the refrigerant loop 21. When the pressure of the high-pressure refrigerant measured by the high-pressure side pressure sensor 83 exceeds an upper limit pressure, the refrigerant loop 21 may be partially blocked. As illustrated in FIG. 1, the high-pressure side pressure sensor 83 may be located between the outlet of the compressor 32 and an inlet of the interior condenser 33. However, the location of the high-pressure side pressure sensor 83 is not limited thereto, and the high-pressure side pressure sensor 83 may be located anywhere in the high-pressure refrigerant conduit 21a.

The low-pressure side pressure/temperature sensor 84 may be disposed on the downstream side of the second expansion valve 16 in the branch conduit 36 to thereby measure the pressure and temperature of the low-pressure refrigerant discharged from the second expansion valve 16. The pressure and temperature of the low-pressure refrigerant measured by the low-pressure side pressure/temperature sensor 84 may be used for optimal control of the second expansion valve 16.

The evaporator temperature sensor 85 may be disposed inside or outside the evaporator 31 to thereby measure the temperature of the evaporator 31 or the temperature of the refrigerant or the air passing through the evaporator 31. The temperature of the refrigerant or the air measured by the evaporator temperature sensor 85 may be used for optimal control of the HVAC subsystem 11.

The controller 100 may properly control the operations of the HVAC subsystem 11, the battery cooling subsystem 12, and the power train cooling subsystem 13 using the outdoor air temperature sensor 81, the humidity sensor 82, the high-pressure side pressure sensor 83, the low-pressure side pressure/temperature sensor 84, the evaporator temperature sensor 85, and the like.

When only the battery pack 41 is cooled without cooling the passenger compartment of the vehicle, the controller 100 may control the compressor 32 of the HVAC subsystem 11 to drive at a predetermined RPM, block the first expansion valve 15 by closing the shut-off valve 15a, and adjust the opening degree of the second expansion valve 16 by controlling the drive motor 16a. Accordingly, the refrigerant may only be directed into the battery chiller 37 without flowing into the first expansion valve 15 and the evaporator 31, and the coolant cooled by the battery chiller 37 may cool the battery.

As described above, when the compressor 32 operates and the shut-off valve 15a of the first expansion valve 15 is closed, the refrigerant may be compressed by the compressor 32 and become the high-pressure refrigerant. The compressed high-pressure refrigerant may be directed into the interior condenser 33 and the exterior condenser 35. The high-pressure refrigerant may be cooled and condensed by the interior condenser 33 and the exterior condenser 35. The cooled refrigerant may flow into the battery chiller 37 through the second expansion valve 16. As the shut-off valve 15a is closed, the flow of the refrigerant into the first expansion valve 15 and the evaporator 31 may be blocked, and accordingly an upstream side pressure (an inlet side pressure) of the first expansion valve 15 may be higher than a downstream side pressure (an outlet side pressure) of the first expansion valve 15.

In a state in which the shut-off valve 15a is closed, the high-pressure refrigerant present in the high-pressure refrigerant conduit 21a may be delivered to the inlet of the first expansion valve 15, and accordingly the upstream side pressure of the first expansion valve 15 may be equal to the pressure of the high-pressure refrigerant present in the high-pressure refrigerant conduit 21a, and the upstream side pressure of the first expansion valve 15 may be relatively high.

In a state in which the shut-off valve 15a is closed, as the low-pressure refrigerant conduit 21b communicates with the branch conduit 36 through the accumulator 38, the low-pressure refrigerant present in the branch conduit 36 may be delivered to the outlet of the first expansion valve 15 through the low-pressure refrigerant conduit 21b, and accordingly the downstream side pressure of the first expansion valve 15 may be equal to the pressure of the low-pressure refrigerant present in the branch conduit 36 and the low-pressure refrigerant conduit 21b, and the downstream side pressure of the first expansion valve 15 may be relatively low.

In a state in which the shut-off valve 15a is closed in order to cool only the battery pack 41, a differential pressure between the upstream side pressure and the downstream side pressure of the first expansion valve 15 may excessively increase. In this state, when the shut-off valve 15a is opened in order to cool the passenger compartment of the vehicle, a relatively large amount of refrigerant may suddenly flow into the internal passage of the first expansion valve 15 due to the differential pressure between the upstream side pressure and the downstream side pressure of the first expansion valve 15, and accordingly excessive noise may be generated in the first expansion valve 15. In particular, when the shut-off valve 15a is closed for cooling only the battery pack 41 for a predetermined period of time, the pressure of the high-pressure refrigerant present in the high-pressure refrigerant conduit 21a (that is, the upstream side pressure of the first expansion valve 15) may excessively increase, and accordingly the differential pressure between the upstream side pressure and the downstream side pressure of the first expansion valve 15 may excessively increase enough to cause noise.

As described above, in order to cool only the battery pack 41, the compressor 32 may be operated and the shut-off valve 15a of the first expansion valve 15 may be closed for a predetermined period of time, and then when the shut-off valve 15a of the first expansion valve 15 is suddenly opened in order to cool the passenger compartment of the vehicle, noise may be generated in the first expansion valve 15. In order to inhibit noise from being generated in the first expansion valve 15, the operation of the compressor 32 may be stopped for a predetermined period of time, and the shut-off valve 15a of the first expansion valve 15 may be opened. When the compressor 32 is stopped and the first expansion valve 15 is kept open, the upstream side pressure and the downstream side pressure of the first expansion valve 15 may become equal to or similar to each other, and accordingly the differential pressure between the upstream side pressure and the downstream side pressure of the first expansion valve 15 may be relieved. Since the cause of noise generation in the first expansion valve 15 is removed, noise may not be generated in the first expansion valve 15. However, since the compressor 32 is stopped for seven minutes or more, cooling and/or dehumidification of the passenger compartment may be relatively delayed, which may lead to customer complaints.

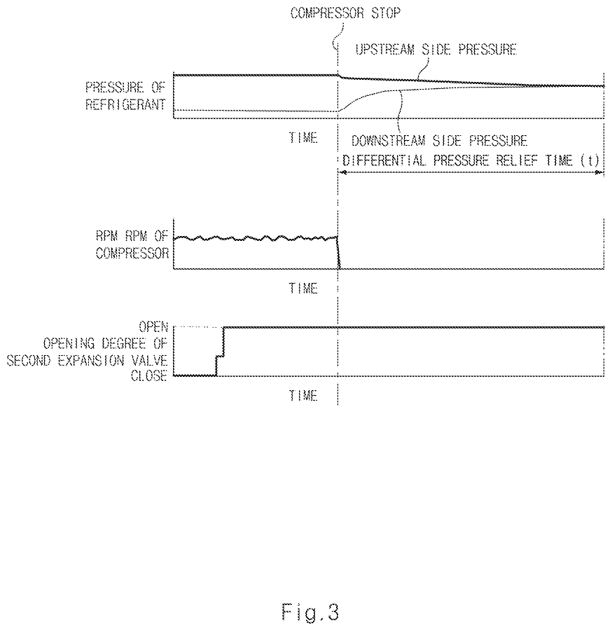

When the cooling of the passenger compartment is desired in a state in which the compressor 32 is operated and the first expansion valve 15 is closed for a predetermined period of time in order to cool only the battery pack 41, the differential pressure between the upstream side pressure and the downstream side pressure of the first expansion valve 15 may be relieved relatively quickly by stopping the operation of the compressor 32 and opening the second expansion valve 16 as illustrated in FIG. 3. For example, a differential pressure relief time t may be about thirty seconds to one minute. In particular, the differential pressure relief time t may correspond to the stop time of the compressor 32.

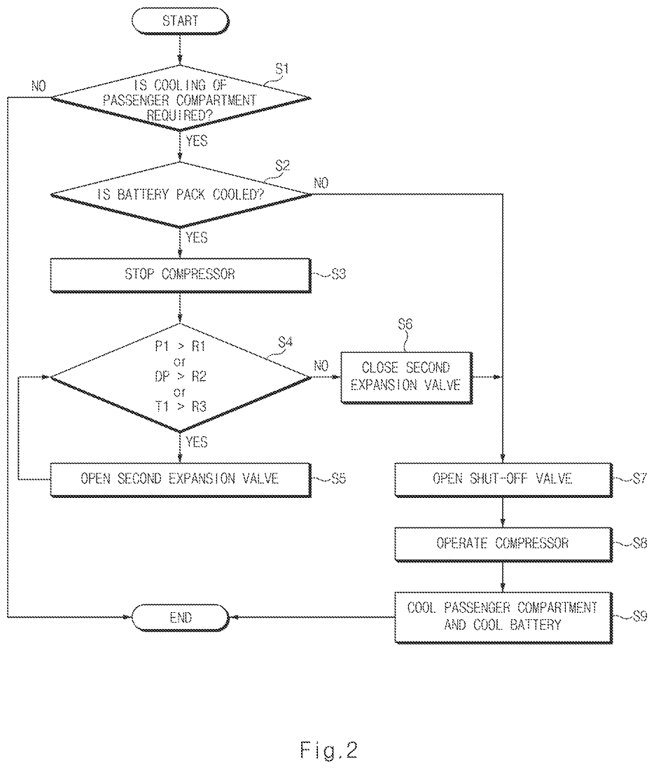

FIG. 2 illustrates a flowchart of a method for controlling pressure in a vehicle thermal management system according to an exemplary form of the present disclosure.

The controller 100 may determine whether cooling of the passenger compartment is desired by a passenger in a state in which cooling is not performed for the passenger compartment of the vehicle (S1). When a signal for cooling the passenger compartment is transmitted to the controller 100, the controller 100 may determine that the cooling of the passenger compartment has been desired.

The controller 100 may determine whether only the battery pack 41 of the electric vehicle is cooled by the battery management system 110 (S2). The controller 100 may check whether the compressor 32 of the HVAC subsystem 11 operates, whether the shut-off valve 15a is closed, and whether the second expansion valve 16 is opened, thereby determining whether only the battery pack 41 of the electric vehicle is being cooled. Specifically, when the compressor 32 operates, the shut-off valve 15a is closed, and the second expansion valve 16 is opened, the controller 100 may determine that only the battery pack 41 is being cooled.

When the controller 100 determines that the battery pack 41 is being cooled, the controller 100 may stop the operation of the compressor 32 (S3).

Thereafter, the controller 100 may determine whether a noise generation condition is satisfied (S4). Here, the noise generation condition refers to a condition in which noise is generated in the first expansion valve 15 when the shut-off valve 15a is opened. As mentioned above, even though the pressure of the low-pressure refrigerant present in the low-pressure refrigerant conduit 21b is kept constant, the pressure of the high-pressure refrigerant present in the high-pressure refrigerant conduit 21a may excessively increase due to the closing of the shut-off valve 15a, and accordingly the differential pressure between the upstream side pressure and the downstream side pressure of the first expansion valve 15 may increase enough to cause noise.

According to an exemplary form, when a pressure P1 of the high-pressure refrigerant present in the high-pressure refrigerant conduit 21a is higher than a reference pressure R1, it may be determined that the noise generation condition is satisfied. The upstream side pressure of the first expansion valve 15 may be equal to the pressure P1 of the high-pressure refrigerant present in the high-pressure refrigerant conduit 21a, and the reference pressure R1 may be a pressure of the high-pressure refrigerant at which noise is not generated in the first expansion valve 15. The reference pressure R1 may be set for each refrigerant temperature according to types of refrigerant. When the pressure P1 of the high-pressure refrigerant is higher than the reference pressure R1, the differential pressure between the upstream side pressure and the downstream side pressure of the first expansion valve 15 may relatively increase, so this may be determined as a condition in which noise is generated in the first expansion valve 15. The pressure P1 of the high-pressure refrigerant may be measured by the high-pressure side pressure sensor 83.

According to another exemplary form, when a differential pressure DP between the upstream side pressure and the downstream side pressure of the first expansion valve 15 is higher than a reference differential pressure R2, it may be determined that the noise generation condition is satisfied. The above-mentioned differential pressure DP may be a difference between the pressure P1 of the high-pressure refrigerant measured by the high-pressure side pressure sensor 83 and the pressure of the low-pressure refrigerant measured by the low-pressure side pressure/temperature sensor 84. The reference differential pressure R2 may be a differential pressure at which noise is not generated in the first expansion valve 15. For example, the reference differential pressure R2 may be about 50 psi or lower.

According to another exemplary form, when a temperature T1 of the refrigerant circulating through the refrigerant loop 21 is higher than a reference temperature R3, it may be determined that the noise generation condition is satisfied. The temperature of the refrigerant may be converted into the pressure of the refrigerant based on various operating conditions of the HVAC subsystem 11. The reference temperature R3 may be a temperature of the refrigerant at which noise is not generated in the first expansion valve 15, and may be set based on the outdoor air temperature of the vehicle. The temperature T1 of the refrigerant may be a temperature of the low-pressure refrigerant measured by the low-pressure side pressure/temperature sensor 84, and the reference temperature R3 may be set based on the outdoor air temperature of the vehicle measured by the outdoor air temperature sensor 81.

When it is determined in S4 that the noise generation condition is satisfied, the controller 100 may open the second expansion valve (S5). After the second expansion valve 16 is opened and a predetermined time has elapsed, the method may return to S4. Specifically, when the second expansion valve 16 is opened and the predetermined time has elapsed, the controller 100 may repeatedly determine whether the noise generation condition is satisfied.

When it is determined in S4 that the pressure P1 of the high-pressure refrigerant is lower than or equal to the reference pressure R1, the differential pressure DP of the first expansion valve 15 is lower than or equal to the reference differential pressure R2, or the temperature T1 of the refrigerant is lower than or equal to the reference temperature R3, the controller 100 may determine that the noise generation condition is not satisfied, and accordingly the controller 100 may close the second expansion valve 16 (S6).

When it is determined in S2 that the battery pack 41 is not cooled or when the second expansion valve 16 is closed in S6, the controller 100 may open the shut-off valve 15a of the first expansion valve 15 (S7).

After the shut-off valve 15a of the first expansion valve 15 is opened, the controller 100 may operate the compressor 32 (S8).

As the shut-off valve 15a is opened and the compressor 32 operates, the refrigerant may circulate through the refrigerant loop via the first expansion valve 15 and the evaporator 31, and accordingly the passenger compartment of the vehicle may be cooled by the HVAC subsystem 11 (S9). At the same time, when the opening degree of the second expansion valve 16 is adjusted by the controller 100, the battery pack 41 may be cooled properly.

As set forth above, by controlling the pressure in the refrigerant loop of the HVAC subsystem when the cooling of the passenger compartment is performed during the cooling of the battery, noise generation may be inhibited. In particular, when the cooling of the passenger compartment is desired in a state in which the compressor is operated and the first expansion valve is closed for a predetermined period of time in order to cool only the battery pack, the differential pressure between the upstream side pressure and the downstream side pressure of the first expansion valve may be relieved relatively quickly by stopping the operation of the compressor and opening the second expansion valve, and thus noise may be inhibited from being generated in the first expansion valve.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure.

What is claimed is:

1. A method for controlling pressure in a vehicle thermal management system including a heating, ventilation, and air conditioning (HVAC) subsystem including a battery cooling subsystem, a battery chiller, and a second expansion valve, the method comprising:
determining, by a controller, whether only a battery pack of the battery cooling subsystem is cooled;
stopping, by the controller, an operation of a compressor of the HVAC subsystem when it is determined that only the battery pack is cooled;
determining, by the controller, whether a noise generation condition is satisfied after stopping the operation of the compressor; and
opening, by the controller, the second expansion valve when it is determined that the noise generation condition is satisfied,
wherein: the noise generation condition is a condition in which noise is generated in the first expansion valve when a shut-off valve is opened,
the HVAC subsystem further includes an evaporator, the compressor, a condenser, a first expansion valve located upstream of the evaporator, and a refrigerant loop fluidly connected to the shut-off valve, the shut-off valve configured to block or unblock flow of a refrigerant into the first expansion valve,
the battery cooling subsystem includes a battery coolant loop fluidly connected to the battery pack,
the battery chiller is configured to transfer heat between a branch conduit, which branches off from the refrigerant loop, and the battery coolant loop, and
the second expansion valve is located upstream of the battery chiller in the branch conduit.

2. The method according to claim 1, wherein determining whether only the battery pack is cooled includes: determining that the compressor operates, the shut-off valve is closed, and the second expansion valve is opened.

3. The method according to claim 1, wherein determining whether the noise generation condition is satisfied includes determining that a pressure of the refrigerant in the refrigerant loop is higher than a reference pressure.

4. The method according to claim 1, wherein determining whether the noise generation condition is satisfied includes determining that a differential pressure between an upstream side pressure and a downstream side pressure of the first expansion valve is higher than a reference differential pressure.

5. The method according to claim 1, wherein determining whether the noise generation condition is satisfied includes determining that a temperature of the refrigerant circulating through the refrigerant loop is higher than a reference temperature.

6. The method according to claim 1, further comprising repeatedly determining, by the controller, whether the noise generation condition is satisfied after the second expansion valve is opened and a predetermined time has elapsed.

7. The method according to claim 1, further comprising, by the controller: closing the second expansion valve, opening the shut-off valve, and operating the compressor when it is determined that the noise generation condition is not satisfied.
